(19) United States
(12) Patent Application Publication
(10) Pub. No.: US 2008/0134568 A1
(43) Pub. Date: Jun. 12, 2008

(54) Apparatus and Method for Emitting Specific Wavelengths of Visible Light to Manipulate the Behavior of Stored Product Insect Pests

(75) Inventors: Thomas Arthur Cowan, Oshawa (CA); Gerhard J. Gries, Coquitlam (CA)

Correspondence Address: OYEN, WIGGS, GREEN & MUTALA LLP;480 - THE STATION, 601 WEST CORDOVA STREET, VANCOUVER, BC, V6B 1G1, omitted

(73) Assignee: PHEROTECH INTERNATIONAL INC., Delta (CA)

(21) Appl. No.: 11/952,377

(22) Filed: Dec. 7, 2007

Related U.S. Application Data
(60) Provisional application No. 60/869,068, filed on Dec. 7, 2006.

(51) Int. Cl. A01M 1/04; A01M 1/14; A01M 25/00; A01P 19/00

(52) U.S. Cl. 43/113; 43/114; 424/84

(57) ABSTRACT

This invention relates to novel apparatus and methods which use specific wavelengths of visible light, or combinations of specific wavelengths of visible light with specific wavelengths of ultra-violet light, to manipulate the behavior of stored product insect pests, including moths and Indian meal moths. The apparatus for attracting stored product insect pests, including (but not limited to) the Indian meal moth, Plodia interpunctella, the Mediterranean flour moth, Ephestia kuhniella, the tobacco moth, Ephestia elutella, the almond moth, Cadra cautella, and the raisin moth, Cadra figulielella, consists of a light source placed in a trap.

### FIELD OF THE INVENTION

This invention relates to novel apparatus and methods which use specific wavelengths of visible light to manipulate the behavior of stored product insect pests in the order Lepidoptera. The invention pertains primarily to the Indian meal moth, Plodia interpunctella, but also is directed at other stored product insect pests, including (but not limited to) the Mediterranean flour moth, Ephestia kuhniella, the tobacco moth, Ephestia elutella, the almond moth, Cadra cautella, the raisin moth, Cadra figulilella and the Angoumois grain moth, Sitotroga cerealella.

### BACKGROUND OF THE INVENTION

The Indian meal moth (IMM) is one of the worst insect pests of stored foods. Larvae infest many food products (Williams 1964; Doud and Phillips 2000), and have even been reported to infest bee hives feeding on pollen (Kwon et al. 2003). This wide variety of resources used by IMM for oviposition and larval development poses a great challenge for pest managers to control IMM damage.

Indoors, IMMs have a continuous life cycle with multiple generations per year. A gravid female lays 200-400 eggs. Hatching larvae develop through five instars and then wander away from the resource for pupation.

Sex pheromone components of female IMM have been identified (Zhu et al. 1999), and synthetic replica could be developed for monitoring populations or for pheromone-based mass trapping or disorientation of mate-foraging males (Foster and Harris 1997). However, there are problems with the use of just synthetic sex pheromones for IMM control. Pheromone-baited traps target only males. Moreover, males not captured in traps or not affected by pheromone-based disorientation will mate with females, and thus maintain populations at high densities (Olsson et al. 2006). Thus, a method of controlling female IMMs has been suggested. Various food sources and their semiochemicals (message bearing chemicals) have been investigated as attractants or oviposition stimulants for gravid female IMMs. Sources shown to induce upwind flight and oviposition by female IMMs, and closely related moths, include nuts and almonds (Hoppe 1981), walnut oil (Nansen and Phillips 2003), acetic acid and isoamyl alcohol (Tóth et al. 2002), wheat odors (Barrer 1977; Barrer and Jay 1980) chocolate products with nuts or rum (Olsson et al. 2005a) or their semiochemicals, such as cyclohexanone, α-pinene, phenylacetaldehyde, cyclohexanol, 3-ethyl-2,5dimethyl-pyrazine, nonanal, vanillin and ethyl vanillin (Olsson et al. 2005b). However, none of these substances induces sufficient attraction to be used in suppression of a pest population.

Stored product insects are also attracted to light. Stermer (1959) released insects into a large chamber, and trapped them at either end after they responded to light sources. The IMM strongly responded to traps associated with ultraviolet light (334 and 365 nm). The almond moth and the Angoumois grain moth were less attracted to traps associated with ultraviolet light and more attracted to traps associated with blue (475 nm), blue-green (500 nm) and yellow (546 nm) than the IMM. Stermer (1959) describes violet-blue light (404.7 nm) as being an “unattractive waveband”. In contrast to Stermer's (1959) behavioral data, Marzke et al. (1970) used electrophysiological recordings to show that the eyes of IMM males and females were least responsive to ultraviolet light (350 nm) and most responsive to yellow light (550-575 nm). Kirkpatrick et al. (1970) found no significant difference in the captures of almond moths, Angoumois grain moths and IMMs to traps emitting green light, ultraviolet light, or both together, whether the traps were offered simultaneously or separately. Soderstrom (1970) found significantly more Mediterranean flour moths and IMMs were captured in suction traps associated with green than ultraviolet light, while almond moths and Angoumois grain moths showed no preference. Finally, Sambaraju and Phillips (2006) tested the response of IMMs released in a shed with one side dark and the other illuminated by white, ultraviolet or green wavelengths. Both sexes responded to the lighted side of the shed, but males responded equally to all three light sources, while females were more attracted to ultraviolet light than to green or white light. However, shining either green or ultraviolet light on traps baited with sex pheromone caused catches to be reduced compared to pheromone-baited control traps, and few moths were captured on sticky traps illuminated with ultraviolet light.

Integrated pest management programs for stored product Lepidoptera, such as the IMM, commonly employ pheromone-baited traps to detect the occurrence and estimate the severity of infestations (Nansen et al. 2004). However, a recent review on the biology and management of the IMM fails to list a single reference on the use of light in the sampling or manipulation of IMM populations (Mohandass et al. 2007). Given the variable and conflicting data cited above, this is not surprising.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

This invention relates to a novel apparatus and methods which use specific wavelengths of visible light, or specific wavelengths of visible light in combination with specific wavelengths of ultra-violet light, to manipulate the behavior of stored product insect pests, including moths and Indian meal moths.

In one embodiment, the invention is a 405 nm (±5 nm) wavelength, or a 405-nm (±5-nm) wavelength in combination with other specific wavelengths of visible or ultra-violet light produced from light-emitting-diodes (LED) or other light sources, to attract males and females of the Indian meal moth, Plodia interpunctella. The LED light sources can be deployed in trapping devices that retain attracted insects.

In another embodiment, the invention can be deployed in combination with other attractants, including (but not limited to) synthetic sex pheromones, natural or synthetic food semiochemicals, and bioacoustic signals.

The invention in broad terms is directed to a method of inducing orientation by stored product insect pests to a light source. The stored product insect pests can be moths, including the Indian meal moth, Plodia interpunctella.

In the method, the effective wavelength range can be 400-475 nm, and the effective intensity ranges can be 50-5000 lux, or 3.8-380 μW measured at 12 cm from the source. In one preferred embodiment, the effective wavelength is about 405 nm. In another preferred embodiment, the effective wavelength is about 405 nm in combination with 350±10 nm. In the method, the light source can be a light emitting diode or narrow band filter.

The stored product moth pests include (but are not limited to) males and females of the following species: the Indian meal moth, Plodia interpunctella, the Mediterranean flour moth, Ephestia kuhniella, the tobacco moth, Ephestia elutella, the almond moth, Cadra cautella, the raisin moth, Cadra figulilella and the Angoumois grain moth, Sitotroga cerealella.

In the method, the light source can be placed in or on a trap. In the method, the stored product moths can be induced to land on or enter the trap, in which they are captured on a sticky surface or inside a receptacle from which they cannot escape.

In the method, the trap can also contain a moth-sound emitting device, and an attractive chemical lure, including (but not limited to) one or more of the following chemicals: (Z,E)-9,12-tetradecadienyl acetate; (Z,E)-9,12-tetradecadienol; (Z,E)-9,12-tetradecadienal; (Z)-9-tetradecenyl acetate; (Z)-11-hexadecenyl acetate; acetic acid; isoamyl alcohol; benzyl alcohol; nonanal; phenylacetaldehyde; hexanol; (E)-2-heptenal; 2-phenylethanol; ethyl decanoate; and geranyl acetone.

In another embodiment, the invention includes an apparatus for attracting stored product insect pests, including (but not limited to) the Indian meal moth, Plodia interpunctella, the Mediterranean flour moth, Ephestia kuhniella, the tobacco moth, Ephestia elutella, the almond moth, Cadra cautella, the raisin moth, Cadra figulielella, and the Angoumois grain moth, Sitotroga cerealella, consisting of a light source placed in a trap.

In a further embodiment of the apparatus, the light source in the trap can be a light emitting diode or narrow band filter. In the apparatus, the insect pest can be Indian meal moth, Plodia interpunctella, and the light source can have an effective wavelength of about 405 nm. The effective light source may also be a wavelength of about 405 nm in combination with other specific wavelengths of visible or ultra-violet light. In the apparatus, the insects that orient to and land on or enter the trap can be captured on a sticky surface or inside a receptacle from which they cannot escape.

In the apparatus, the trap can also contain a moth-sound emitting device, and an attractive chemical lure, including (but not limited to) one or more of the following chemicals: (Z,E)-9,12-tetradecandienyl acetate; (Z,E)-9,12-tetradecadienol; (Z,E)-9,12-tetradecadienal; (Z)-9-tetradecenyl acetate; (Z)-11-hexadecenyl acetate; acetic acid; isoamyl alcohol; benzyl alcohol; nonanal; phenacetaldehyde; hexanol; (E)-2-heptenal; 2-phenylethanol; ethyl decanoate; and geranyl acetone.

In addition to the exemplary aspects and embodiments described above, further aspects and embodiments will become apparent by reference to the drawings and by study of the following detailed descriptions.

### DRAWINGS

Exemplary embodiments are illustrated in referenced figures of the drawings. It is intended that the embodiments and figures disclosed herein are to be considered illustrative rather than restrictive.

FIG. 1 illustrates the scheme of the experimental design employed in two-choice or four-choice experiments.

FIG. 2 illustrates graphical data of mated female Indian meal moths responding in still-air, two-choice laboratory Experiments 1-3 to various light sources, each tested at a light intensity of 53-170 lux.

FIG. 3 illustrates graphical data of male, mated female and virgin female Indian meal moths responding in still air, four-choice laboratory Experiments 4-6 to various light sources, each emitting 15 μW per 1 cm².

FIG. 4 illustrates graphical data of mated female Indian meal moths responding in still-air, two-choice laboratory Experiments 4-6 to blue light (400-475 nm) of different intensities.

FIG. 5 illustrates graphical data of mated female Indian meal moths responding in still-air, four-choice laboratory Experiment 10 to specific wavelengths (405, 435, 450 or 470 nm) in the blue-light wavelength range (400-475 nm).

FIG. 6 illustrates graphical data of mated female Indian meal moths responding in still-air, four-choice laboratory Experiment 11 to specific wavelengths (405, 435, 450 or 470 nm) in the blue-light wavelength range (400-475 nm), each tested at 200 μW per 1 cm².

FIG. 7 illustrates graphical data of male, virgin female and mated female Indian meal moths responding in still-air, two-choice laboratory Experiments 12-14 to a source of blue light (400-475 nm) and a specific wavelength (405 nm) each tested at an intensity of 1,000 lux.

FIG. 8 illustrates graphical data of male, virgin female and mated female Indian meal moths responding in still-air, four-choice laboratory Experiments 15-17 to Light Emitting Diodes (LEDs) emitting at 30 μW per 1 cm² a peak wavelength of 505, 525, 565 or 572 nm.

FIG. 9 illustrates graphical data of mated female Indian meal moths responding in still-air, two-choice laboratory Experiment 18 to a single wavelength (405-nm LED) or to a wavelength combination (405-nm LED plus 350-nm LED), with single or combined wavelength stimuli tested at identical light intensity (200 μW per 1 cm²).

### DETAILED DESCRIPTION OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

### Experimental Insects

Indian meal moth (IMM) larvae, Plodia interpunctella, were obtained from infested cereal bars provided by Pherotech International Inc. Larvae were reared at 27° C. at a photoperiod of 17 hours light and 7 hours dark. The rearing medium was modified from Le Cato (1976) and consisted of whole wheat flour (27.5% by volume), yellow cornmeal (27.5%), Purina One dog food (13.5%), brewers yeast (6.9%), honey (6.9%), glycerine (6.9%; 96% pure), Quaker rolled oats (6.8%) and wheat germ (3.4%).

Fifth instar larvae were separated by sex and placed in groups of 12-15 specimens into Petri dishes (10 cm diam), containing corrugated cardboard as pupation sites. Eclosed adults were kept under the same conditions as larvae (see above). To obtain gravid females, 3-4 virgin males and 2-3 virgin females were kept together during the dark phase in small cages (10×10×10 cm). The next day, females were assumed mated and were used for colony rearing or laboratory experiments. All adult moths used in laboratory experiments were 2-5 days old.

### General Experimental Design

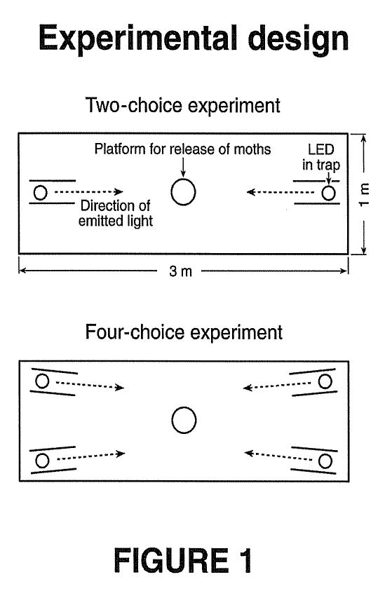

Still-air, two- or four-choice laboratory bioassays (Experiments 1-10) were conducted in a modified wind tunnel (1×1×3 m long) with air entry and exit sections covered by mesh screens, and also by black paper in Experiments 4-10 to minimize light reflection (FIG. 1).

FIG. 1 illustrates the scheme of the experimental design employed in two-choice or four-choice experiments. Traps, the platform for releasing moths and Light-Emitting-Diodes (LED) are drawn not to scale.

For each replicate, two Petri dishes with ≦5 insects each were placed on a 50-cm tall, black felt-covered platform (23×30 cm) in the centre of the tunnel. In two-choice experiments, a green Delta trap (Pherotech International Inc.) was affixed to a metal pole at a height of 50 cm, and was positioned to the left and right of, and 1.5 m apart from, the release platform. In four-choice Experiment 7, the design was identical except that one trap was near (30 cm; 45° angle) each corner of the tunnel. Light sources as test stimuli were randomly assigned to, and mounted within, traps. All experiments were conducted in the first 2 hours of the 7-hour dark phase, when IMMs forage for mates or suitable oviposition sites.

An experimental replicate was initiated by lifting the lid of each Petri dish on the release platform, and was terminated by scoring the number of moths captured in each trap two hours later. All moths not responding were removed from the wind tunnel prior to initiating a new experimental replicate. After each set of three replicates, the wind tunnel was wiped with 70% ethanol and left to “aerate” overnight.

### Experiments 1-3

### Relative Attractiveness of White, Red, Green and Blue Light Sources to Mated Females Tested in Two-Choice Experiments

To determine the spectrum of visible light that is most effective in attracting IMMs, a 6-volt light bulb connected to a 9-volt power source was placed inside a 2-ml glass vial (10×28 mm) which filtered out ultraviolet light. The glass vial, in turn, was surrounded by a cylindrical (5.5×10.5 cm diam) flexible filter (Lee Filters, Hamshire, England) that generated light spectra in the blue range (400-475 nm, peaking at 400, 425 and 450 nm; referred to as “Rose Purple 7”), green range (475-600 nm, peaking at 510 nm, 545 nm, and 575 nm; “lime 8”) and red range (575-750, peaking at 610 nm and 655 nm; “orange 9”). A clear filter (heat shield #269) was used to generate white light. Light intensities were measured with a Mastersix photometer (Gossen Foto- und Lichtmesstechnik, Nürnberg, Germany) with the diffuser removed so that low-light levels could be measured. All light sources were tested at an intensity of 53-170 lux.

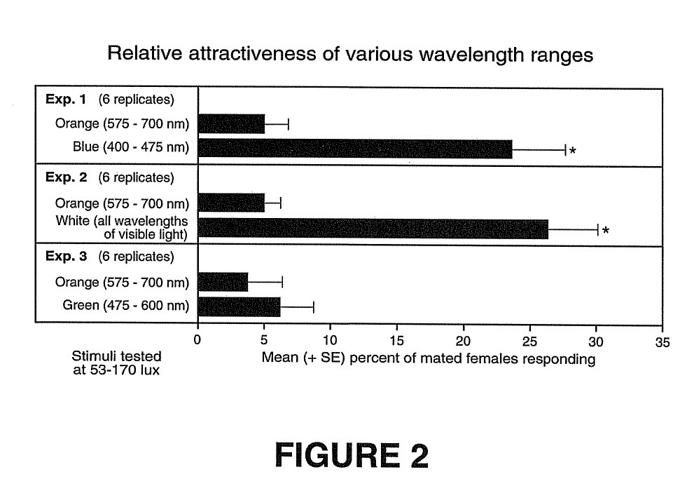

In two-choice Experiments 1-3, it was found that gravid female IMMs preferred blue light over red light (Experiment 1), and white light (containing blue light) over red light (Experiment 2), but failed to show a significant preference for red or green light, which were equally unattractive (Experiment 3) (see FIG. 2). This unexpected result shows for the first time a preference for visible light of a defined wavelength over white light that includes that defined wavelength. Sambaraju and Phillips (2006) showed this for ultraviolet, but not visible, light.

FIG. 2 illustrates graphical data of mated female Indian meal moths responding in still-air, two-choice laboratory Experiments 1-3 to various light sources, each tested at a light intensity of 53-170 lux. In each experiment, an asterisk (*) indicates a statistically significant preference for the respective test stimulus; Wilcoxon paired-sample test, P<0.05.

### Experiments 4-6

### Relative Attractiveness of Various Wavelength Ranges to Males, Virgin Females and Mated Females Tested in Four-Choice Experiments

To further determine the spectrum of visible light that is most effective in attracting IMMs, four-choice experiments were conducted. Modified desk lamps (Espressivo, Ikea) with 20-watt halogen bulbs were used as light sources to test the response of males (Experiment 4), virgin females (Experiment 5) and mated females (Experiment 6). Each desk lamp was connected to a rheostat to adjust light intensity, and the halogen bulb was fitted with a black cardboard cylinder (8×12 cm wide), with the light filter mounted at the front 8 cm apart from the bulb. The cylinder projected the light in one direction. Flexible filters (Lee Filters, Hamshire, England) that generated light spectra in the blue range (400-475 nm, referred to as “Rose Purple 7”), green range (475-600 nm, “lime 8”), orange range (525-750 nm, “orange 9”) or red range (590-800 nm, “light Red”). Filter spectra and light intensities were measured with an HR4000 high-resolution spectrometer (Ocean Optics Dunedin Fla.). All light sources were tested at an intensity of 15 μW/cm² integrated from 350-700 nm measured at the filter, 8 cm from the halogen light source.

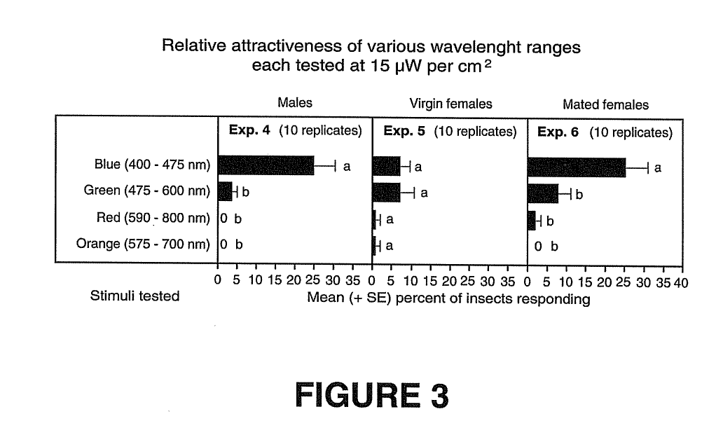

In four-choice Experiments 4-6, it was found that males and mated females showed a significant preference for blue light over red, green and orange light, but that virgin females had no preference for any wavelength range (FIG. 3).

FIG. 3 illustrates graphical data of male, mated female and virgin female Indian meal moths responding in still air, four-choice laboratory Experiments 4-6 to various light sources, each emitting 15 μW per 1 cm². In each experiment, bars with different letters are significantly different; analysis of variance with Tukey's test for multiple comparison of means, P<0.05.

### Experiments 7-9

### Effect of Intensity of Blue Light (400-475 Nm) to Attract IMMs

To determine the intensity of blue light (400-475 nm) most effective in attracting gravid female IMMs, light intensities of 50 versus 200 lux (Experiment 7), 200 versus 1,000 lux (Experiment 8), and 1,000 versus 3,000 lux (Experiment 9) were tested in two-choice experiments. In all three experiments, the filter “Rose Purple 7” (see above) was used to generate blue light, but the light sources differed. In Experiment 7, the light source consisted of a 6.4-volt bulb connected to a 100-ohm adjustable resistor powered at 9 volts. Experiments 8 and 9 deployed a modified desk lamp (Espressivo, Ikea) with a 20-watt halogen bulb to generate light intensities of 1,000 lux and 3,000 lux. The desk lamp was connected to a rheostat to adjust light intensities. The halogen bulb was fitted with a black cardboard cylinder (8×12 cm wide), with the filter “Rose Purple 7” mounted at the front, 8 cm apart from the bulb. The cylinder projected the light in one direction.

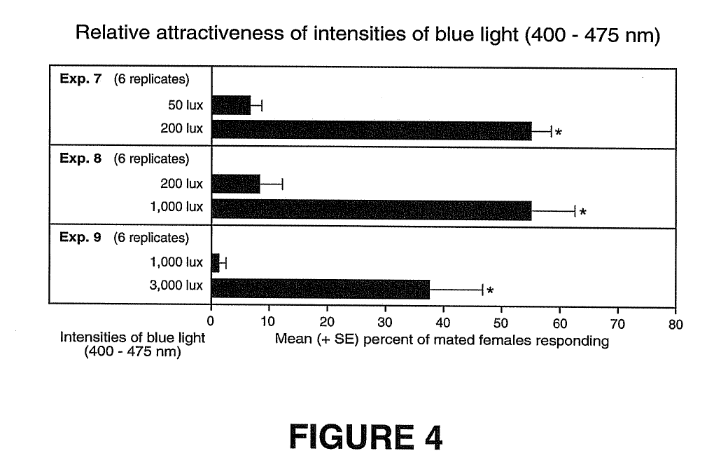

In each of Experiments 7-9, it was found that mated female IMMs preferred the blue light of greater intensity over that of lower intensity (FIG. 4).

FIG. 4 illustrates graphical data of mated female Indian meal moths responding in still-air, two-choice laboratory experiments 7-9 to blue light (400-475 nm) of different intensities. In each experiment, an asterisk (*) indicates a statistically significant preference for the respective test stimulus; Wilcoxon paired-sample test, P<0.05.

### Experiment 10

### Attractiveness of Specific Wavelengths in the Blue Light Spectrum (400-475 nm) Each Tested at a Light Intensity of 200 lux

To determine the wavelength in the blue light spectrum (400-475 nm) most effective in attracting mated female IMMs, Light-Emitting-Diodes (LED; Roithner Lasertechnik, Vienna, Austria) with peak wavelengths of 405 nm (range: 400-410 nm), 435 nm (range: 410-470 nm), 450 nm (range: 440-460 nm) and 470 nm (range: 465-475 nm) were tested in four-choice Experiment 10. For each replicate, one of the four LEDs was randomly assigned to, and mounted within, one of four Green Delta Traps (see general experimental design; FIG. 1), using a resistor to adjust the intensity of each LED to 200 lux.

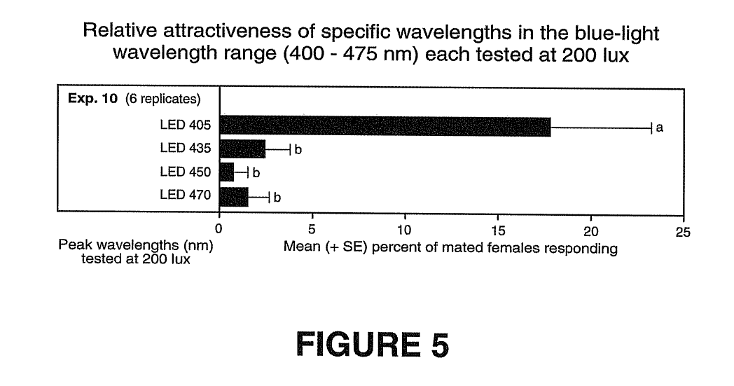

In Experiment 10, it was found that the LED with peak wavelength 405 nm was significantly more effective than LEDs with peak wavelength 435 nm, 450 nm or 470 nm in attracting gravid female IMMs. The latter three peak wavelengths were equally unattractive to female moths (see FIG. 5).

FIG. 5 illustrates graphical data of mated female Indian meal moths responding in still-air, four-choice laboratory experiment 10 to specific wavelengths (405, 435, 450 or 470 nm) in the blue-light wavelength range (400-475 nm). Bars with different letters are significantly different; analysis of variance with Tukey's test for multiple comparison of means, P<0.05.

### Experiment 11

### Attractiveness of Specific Wavelengths in the Blue-Light Spectrum (400-475 nm) Each Tested at a Light Intensity of 200 μW Per 1 cm²

To further determine the wavelength in the blue light spectrum most effective in attracting mated females, an additional four-choice experiment (Experiment 11) was conducted. The experimental design was identical to that of Experiment 10 except that the LEDs were calibrated to emit 200 μW per 1 cm², integrated from 350-550 nm using a HR4000 high-resolution spectrometer (Ocean Optics Dunedin Fla.).

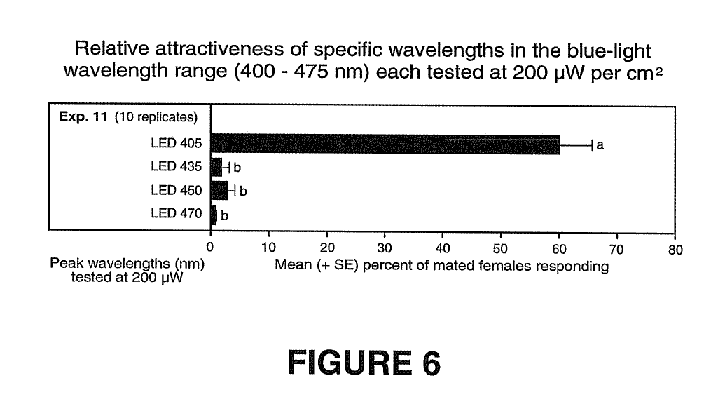

In Experiment 11, it was found that the LED with peak wavelength 405 nm was significantly more effective in attracting gravid females than were LEDs with peak wavelength 435 nm, 450 nm or 470 nm. The latter three peak wavelengths were equally unattractive to female moths (FIG. 6).

FIG. 6 illustrates graphical data of mated female Indian meal moths responding in still-air, four-choice laboratory Experiment 11 to specific wavelengths (405, 435, 450 or 470 nm) in the blue-light wavelength range (400-475 nm), each calibrated at 200 μW per 1 cm². Bars with different letters are significantly different; analysis of variance with Tukey's test for multiple comparison of means, P<0.05; LED=Light Emitting Diode.

### Experiments 12-14

### Attractiveness of “LED 405” and the Blue-Light Spectrum 400-475 nm to Males, Virgin Females and Mated Females

To compare the relative attractiveness of blue light (400-475 nm) and specific wavelength 405 nm (+/−5 nm), both light sources at 200 lux each were tested in two-choice experiments 8-10, with males (Experiment 12), virgin females (Experiment 13) and mated females (Experiment 14) as bioassay insects. The blue-light spectrum was generated from a desk lamp (Espressivio, Ikea) with a Halogen bulb, fitted with a cardboard cylinder (8×12.5 cm diam) for projecting the light and carrying the filter “Rose Purple 7” (as described for experiments 4-6). To standardize visual stimuli, the same set-up was used for the “405-nm LED” which was mounted just in front of the turned-off Halogen bulb.

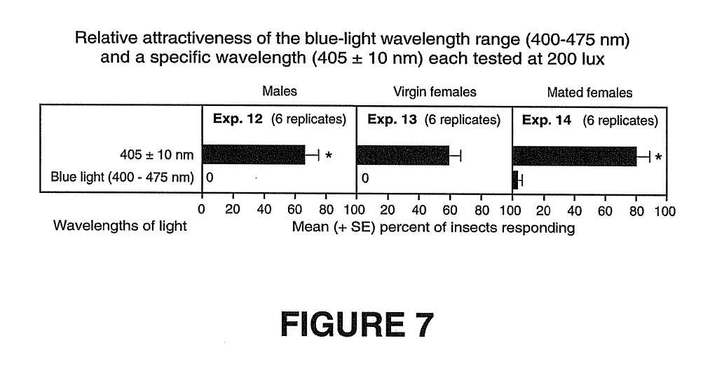

In two-choice Experiments 12-14, it was found that males (Experiment 12), virgin females (Experiment 13) and mated females (Experiment 14), all preferred the LED with peak wavelength 405 nm over the blue-light spectrum 400-475 nm (FIG. 7). This result was surprising and unexpected, given that Indian meal moths, and other stored product moths, were not highly attracted to light of an almost identical wavelength (404.7 nm), which was described by Stermer (1959) as an “unattractive waveband”.

FIG. 7 illustrates graphical data of male, virgin female and mated female Indian meal moths responding in still-air, two-choice laboratory Experiments 12-14 to a source of blue light (400-475 nm) and a specific wavelength (405 nm) each tested at an intensity of 200 lux. In each experiment, an asterisk (*) indicates a significant preference for the respective test stimulus; Wilcoxin paired-sample test, P<0.05.

### Experiment 15-17

### Attractiveness of Specific Wavelengths in the Green-Light Spectrum (505-572 nm) Each Tested at a Light Intensity of 30 μW Per 1 Cm²

Considering that green light (475-600 nm) was somewhat attractive (although not statistically significant) to males, virgin females and mated females in Experiments 4-6 (see FIG. 3), and that attraction of IMM to green light is reported in the literature (Stermer 1959; Soderstrom 1970; Kirkpatric and Marzke 1970), four-choice bioassays (Experiments 15-17) were designed to determine the specific wavelength(s) responsible for the attractiveness. Light-Emitting-Diodes (LED) with peak wavelengths of 505 nm, 525 nm, 565 nm or 572 nm (Roithner Lasertechnik, Vienna, Austria) were deployed to test the response of males (Experiment 15), virgin females (Experiment 16) and mated females (Experiment 17). For each replicate, one of the four LEDs was randomly assigned to, and mounted within, one of four Green Delta Traps (see general experimental design; FIG. 1), adjusting with a resistor the intensity of each LED to 30 μW per 1 cm².

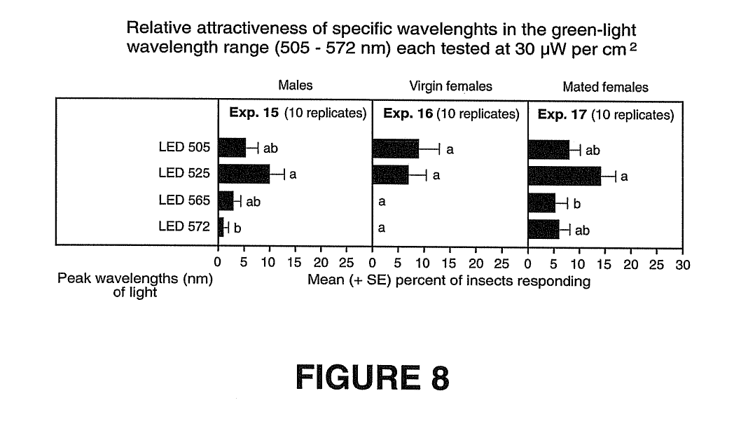

In Experiments 15-17, it was found that there was a weak preference by males, virgin females and mated females to LEDs emitting a peak wavelength of 505 nm or 525 nm (FIG. 8). In Experiment 15, the 525-nm LED attracted significantly more males than did the 572-nm LED. In Experiment 17, the 525-nm LED attracted significantly more mated females than did the 565-nm LED (FIG. 8).

FIG. 8 illustrates graphical data of male, virgin female and mated female Indian meal moths responding in still-air, four-choice laboratory Experiments 15-17 to Light Emitting Diodes (LEDs) emitting at 30 μW per 1 cm² a peak wavelength of 505, 525, 565 or 572 nm. Bars with different letters are significantly different; analysis of variance with Tukey's test for multiple comparison of means, P<0.05.

### Experiment 18

### Attractiveness of Wavelength 405 nm (+/−5 nm) Tested Alone or in Combination with Wavelength 350 nm (+5/−nm)

To determine whether attraction of mated female IMMs to the wavelength 405 nm would increase in the presence of another specific wavelength, two-choice experiment 18 (see FIG. 1) tested a single LED emitting peak wavelength 405 nm at 200 μW per 1 cm² versus two LEDS, one of which emitting the peak wavelength 405 nm at 180 μW per 1 cm² and the other LED emitting the peak wavelength 350 nm at 20 μW per 1 cm². Great care was taken to adjust to 200 μW per 1 cm² the total light intensity emitted from either the single LED or the paired LEDs. For each replicate, the paired LEDs were positioned on top of each other and mounted within a green delta trap, using a resistor to adjust the intensity of each LED. The position of test stimuli (see FIGURE 1) was alternated between replicates.

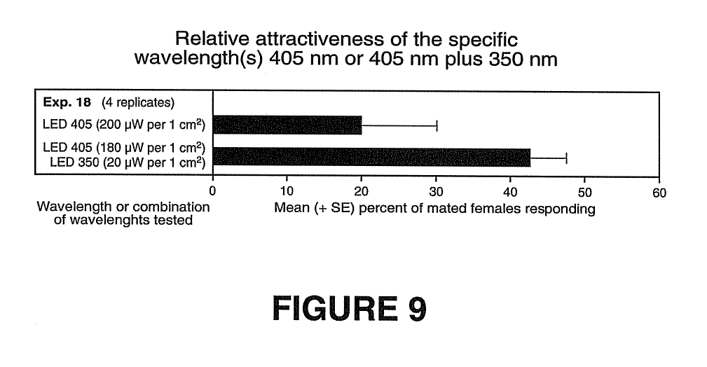

In experiment 18, it was found that the paired 405-nm and 350-nm LEDs attracted more mated females than did the single 405-nm LED (FIG. 9). This indicates that attraction of IMMs to a 405-nm LED can be improved by addition of other specific wavelengths.

FIG. 9 illustrates graphical data of mated female Indian meal moths responding in still-air, two-choice laboratory Experiment 18 to a single wavelength (405-nm LED) or to a wavelength combination (paired 405-nm LED and 350-nm LED), with single or combined wavelength stimuli tested at identical light intensity (200 μW per 1 cm²).

In all experiments which tested the effective wavelength 405±5 nm, a large proportion of all moths released into the modified wind tunnel (see FIG. 1) were captured within just two hours, indicating that this technology has great potential for suppression of IMM populations in private households and industrial settings.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

### REFERENCES

Barrer, P. M. (1977) Influence of airborne stimulation from conspecific adults on site of oviposition of Ephestia cautella (Lepidoptera-Phycitidae). Entomologia Experimentalis et Applicata 22: 13-22.
Barrer, P. M., Jay, E. G. (1980) Laboratory observations on the ability of Esphestia cautella (Walker) (Lepidoptera, Phycitedaeo) to locate and to oviposit in response to a source of grain odor. Journal of Stored Product Research 16: 1-7.
Doud, C. W. and Phillips, T. W. (2000) Activity of Plodia interpunctella (Lepidoptera: Pyralidae) in and around flour mills. Journal of Economic Entomology 93: 1842-1847.
Foster, S. P. and Harris, M. O. (1997) Behavioral manipulation methods for insect pest-management. Annual Review of Entomology 42: 123-46.
Hoppe, T. (1981) Food preference, oviposition and development of the Indian meal moth Plodia interpunctella (Hubner) on different products of the chocolate industry. Zeitschrift für Angewandte Entomologie 91: 170-179.
Kirkpatrick, R. L., Yancey, D. L. and Marzke, F. O. (1970) Effectiveness of green and ultraviolet light in attracting stored-product insects to traps. Journal of Economic Entomology 63: 1853-1855.
LeCato, G. L. (1976) Yield, development, and weight of Cadra cautella (Walker) and Plodia interpunctella (Hubner) on 21 diets derived from natural products. Journal of Stored Product Research 12: 43-47.
Mohandass, S., Arthur, F. H., Zhu, K. Y. and Throne, J. E. (2007) Biology and management of Plodia interpunctella (Lepidoptera: Pyralidae) in stored products. Journal of Stored Products Research 43: 302-311.
Marzke, F. O., Street, M. W., Mullen, M. A. and McCray, T. L. (1973) Spectral responses of six species of stored-product insects to visible light. Journal of the Georgia Entomological Society 8: 195-200.
Nansen, C. and Phillips, T. W. (2003) Ovipositional responses of the Indian meal moth, Plodia interpunctella (Hubner) (Lepidoptera: Pyralidae), to oils. Annals of the Entomological Society of America 96: 524-531.
Nansen, C., Phillips, T. W. and Sanders, S. (2004) Effects of height and adjacent surfaces on captures of Indianmeal moth (Lepidoptera: Pyralidae) in pheromone-baited traps. Journal of Economic Entomology 97: 1284-1290.
Olsson, P. O., Anderbrant, O. and Löfstedt, C. (2006) Attraction and oviposition of Ephestia kuehniella induced by volatiles identified from chocolate products. Entomologia Experimentalis et Applicata 119: 137-144.
Olsson, P. O., Anderbrant O., Löfstedt, C. (2005a) Flight and oviposition behavior of Ephestia cautella and Plodia interpunctella in response to odors of different chocolate products. Journal of Insect Behavior 18: 363-380.
Olsson, P. O., Anderbrant O., Löfstedt C., Borg-Karlson, A. and Liblikas I. (2005b) Electrophysiological and behavioral responses to chocolate volatiles in both sexes of the pyralid moths Ephestia cautella and Plodia interpuntcella. Journal of Chemical Ecology 31.
Sambaraju, K. R. and Phillips, T. W. (2006) Behavioral responses of Plodia interpunctella (Lepideroptera: Pyralidae) to light. Poster presented at the annual meeting of the Entomological Society of America, Indianapolis, Ind., 10-13 Dec. 2006.
Soderstrom, E. L. (1970) Effectiveness of green electroluminescent lamps for attracting stored-product insects. Journal of Economic Entomology 63: 726-731.
Stermer, R. A. (1959) Spectral response of certain stored-product insects to electromagnetic radiation. Journal of Economic Entomology 52: 888-892.
Tóth, M., Repasi, V. and Szöcs, G. (2002) Chemical attractants for females of pest pyralids and phycitids (Lepidoptera: Pyralidae, Phycitidae). Acta Phytopathologica et Entomologica Hungarica 37: 375-384.
Williams, C. G. (1964) Life-History of Indian meal moth Plodia interpunctella (Hubner) (Lep.: Pycitidae) in warehouse in Britain and on different foods. Annals of Applied Biology 53: 459.
Yong Jung, K., Shafqat S. and Marie Jose, D. (2003) Control of Plodia interpunctella (Lepidoptera: Pyralidae), a pest in Bombus terrestris (Hymenoptera: Apidae) colonies. The Canadian Entomologist 135: 893-902.
Zhu J., Ryne C., Unelius C. R., Baleru P. G. and Löfstedt C. (1999) Re-identification of the female sex pheromone of the Indian meal moth, Plodia interpuctella: evidence for a four-component blend. Entomologica Experimentalis et Applicata 92: 137-146.

What is claimed is:

1. A method of inducing orientation by stored product insect pests by exposing said stored product insect pests to light within specific wavelength ranges, wherein the effective wavelength ranges of the light are 400-475 nm, 405±5 nm and 505-525 nm, and the effective intensity ranges from 50-5000 lux, or 3.8-380 μW measured at 12 cm from the source.

2. The method of claim 1, wherein combinations of wavelengths are used to enhance orientation.

3. The method of claim 2, wherein the effective wavelength of 405±5 nm is combined with one or more effective wavelengths selected from the group consisting of 350±10 nm, 365±10 nm, 380±10 nm, 505±10 nm and 525±10 nm.

4. The method of claim 1, wherein the light source is a light emitting diode or a narrow band filter.

5. The method of claim 1, wherein the stored product moth pests include males and females of the following species: the Indian meal moth, Plodia interpunctella, the Mediterranean flour moth, Ephestia kuhniella, the tobacco moth, Ephestia elutella, the almond moth, Cadra cautella, the raisin moth, Cadra figulilella, and the Angoumois grain moth, Sitotroga cerealella.

6. The method of claim 1 wherein the insect pest is Indian meal moth, Plodia interpunctella.

7. The method of claim 3 wherein the insect pest is Indian meal moth, Plodia interpunctella.

8. The method of claim 1 wherein the source of light is placed in or on a trap.

9. The method of claim 8 wherein the stored product moths are induced to land on or enter the trap, in which they are captured on a sticky surface or inside a receptacle from which they cannot escape.

10. The method of claim 9 wherein the trap is used to monitor for infestations of stored product moth pests.

11. The method of claim 9 wherein the trap is used to suppress populations of stored product moth pests.

12. The method of claim 10 wherein the stored product moth pests include males and females of the following species: the Indian meal moth, Plodia interpunctella, the Mediterranean flour moth, Ephestia kuhniella, the tobacco moth, Ephestia elutella, the almond moth, Cadra cautella, the raisin moth, Cadra figulilella and the Angoumois grain moth, Sitotroga cerealella.

13. The method of claim 8 wherein the trap also contains a moth-sound emitting device, and an attractive chemical lure, including one or more of the following chemicals: (Z,E)-9,12-tetradecadienyl acetate; (Z,E)-9,12-tetradecadienol; (Z,E)-9,12-tetradecadienal; (Z)-9-tetradecenyl acetate; (Z)-11-hexadecenyl acetate; acetic acid; isoamyl alcohol; benzyl alcohol; nonanal; phenylacetaldehyde; hexanol; (E)-2-heptenal; 2-phenylethanol; ethyl decanoate; and geranyl acetone.

14. An apparatus for attracting stored product insect pests, including the Indian meal moth, Plodia interpunctella, the Mediterranean flour moth, Ephestia kuhniella, the tobacco moth, Ephestia elutella, the almond moth, Cadra cautella, the raisin moth, Cadra figulielella and the Angoumois grain moth, Sitotroga cerealella, consisting of a light source placed in a trap, wherein the effective wavelength ranges of the light source are 400-475 nm, 405±5 nm or 505-525 nm, and the effective intensity ranges from 50-5000 lux, or 3.8-380 μW measured at 12 cm from the light source.

15. The apparatus of claim 14 wherein the light source in the trap is a light emitting diode or narrow band filter.

16. The apparatus of claim 14 wherein the insect pest is Indian meal moth, Plodia interpunctella, and the light source consists of the wavelength 405±5 nm in combination with other effective wavelengths selected from the group consisting of 350±10 nm, 365±10 nm, 380±10 nm, 505±10 nm and 525±10 nm.

17. The apparatus of claim 14 wherein the insects that orient to and land on or enter the trap are captured on a sticky surface or inside a receptacle from which they cannot escape.

18. The apparatus of claim 14 wherein the trap also contains a moth-sound emitting device, and an attractive chemical lure, including (but not limited to) one or more of the following chemicals: (Z,E)-9,12-tetradecandienyl acetate; (Z,E)-9,12-tetradecadienol; (Z,E)-9,12-tetradecadienal; (Z)-9-tetradecenyl acetate; (Z)-11-hexadecenyl acetate; acetic acid; isoamyl alcohol; benzyl alcohol; nonanal; phenacetaldehyde; hexanol; (E)-2-heptenal; 2-phenylethanol; ethyl decanoate; and geranyl acetone.
